(19) United States
(12) Patent Application Publication
(10) Pub. No.: US 2010/0153182 A1
(43) Pub. Date: Jun. 17, 2010

(54) PRODUCT ADVERTISING AND SUPPLY CHAIN INTEGRATION

(75) Inventors: Michael Sean Quinn, Berkeley, CA (US); Keith Ball, San Jose, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-billancourt (FR)

(21) Appl. No.: 12/451,201

(22) PCT Filed: Apr. 30, 2008
(86) PCT No.: PCT/US2008/005537

§ 371 Date: Feb. 19, 2010

Related U.S. Application Data
(60) Provisional application No. 60/927,085, filed on May 1, 2007.

(51) Int. Cl. G06Q 10/00; G06Q 30/00; G06Q 90/00

(52) U.S. Cl. 705/10; 705/7; 705/500; 705/14.4

(57) ABSTRACT

A method, apparatus and system are provided that enable an advertising supply chain and product supply chain to inter-communicate and integrate media content advertising with product supply to optimize the effectiveness of out-of-home advertising and ensure the availability of advertised products. As a result, the effectiveness of retail media programs will be enhanced with processes and tools that coordinate and/or integrate the delivery to and presentation of product specific media and the delivery to and presentation of the products themselves on location.

### FIELD OF THE INVENTION

The present invention generally relates to advertising media and, more particularly, to a method, apparatus and system for the integration of product advertising and product supply means.

### BACKGROUND OF THE INVENTION

Content distribution systems are used to provide content to a plurality of end systems. For example, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at a respective set-top-box for each display or group of displays. Retailers use the displays to present their current offerings or sale information, while the public spaces sell time on the video displays to advertisers either national or local, knowing that large numbers of consumers will see the presentation. One of the purposes of Retail Media Advertising is to increase the sale of products. This is accomplished in one example by displaying information about specific products in specific retail locations.

However, there are drawbacks to the currently available media advertising models, such as those described above. That is, currently, there are no processes, services and/or tools that enable providers of retail media networks to coordinate the delivery and presentation of their media with the delivery and presentation of products. More specifically, in currently available advertising systems there exist no means of ensuring that products being advertised are actually available or in stock at the advertising locations. As such, media advertisements may be running for products not available. Such situations not only amount to a waste of advertising revenue, but can also lead to consumer dissatisfaction if such advertising airs in stores where there is not sufficient inventory to support consumer demand.

As such, there is thus a need for a new means of retail advertising which overcomes the above described deficiencies in the state of the art as well as other related deficiencies and which provides for the integration of product advertising and product availability.

### SUMMARY OF THE INVENTION

Embodiments of the present invention address the deficiencies of the prior art by providing a method, apparatus and system for enabling the integration of product advertising and product supply means.

In various embodiments of the present invention, a method, apparatus and system are provided that enable an advertising supply chain and product supply chain to inter-communicate and integrate media content advertising with product supply to optimize the effectiveness of in-store advertising and ensure product availability.

For example, in one embodiment of the present invention a method for product advertising and supply chain integration includes using product advertising information and supply information to determine if a product to be advertised will be available at a location of the advertising during a time of the advertising of the product and in response to the determination that a product to be advertised will not be available, communicating a request for the product to be delivered to the location of the advertising before the time of the advertising of the product.

In an alternate embodiment of the present invention a supply chain integration manager includes a product advertising/supply chain input-output circuit for receiving product advertising information and product supply information and an integration processor for using the received product advertising information and product supply information for determining if a product to be advertised will be available at a location of the advertising during a time of the advertising of the product, and in response to determining that the product to be advertised will not be available, communicating a request for the product to be delivered to a location at which the product is to be advertised before the time of the advertising of the product.

In yet an alternate embodiment of the present invention a system for product advertising and supply chain integration includes a first means for providing product advertising information, a second means for providing product supply information, a third means for receiving the product advertising information and product supply information and using the received product advertising information and product supply information for determining if a product to be advertised will be available at a location of the advertising during a time of the advertising of the product, and in response to determining that the product to be advertised will not be available, communicating a request for the product to be delivered to a location at which the product is to be advertised before the time of the advertising of the product.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising;

FIG. 3 depicts a high level functional block diagram of the integration of the content distribution system of FIG. 1 with a product supply chain working in parallel and with similar functions in accordance with an embodiment of the present invention;

FIG. 4 depicts a high level block diagram of a Supply Chain Manager 350 suitable for use in the integrated system of FIG. 3 in accordance with one embodiment of the present invention;

FIG. 5 depicts a more specific high level block diagram of a system for product advertising and supply chain integration in accordance with an embodiment of the present invention;

FIG. 6 depicts a high level flow diagram of a method for product advertising and supply chain integration in accordance with an embodiment of the present invention; and

FIG. 7 depicts a table depicting an exemplary Proof-of-Performance report in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for the integration of product advertising and product supply means. Although the present invention will be described primarily within the context of an in-store product advertising environment having a specific supply chain means, the specific embodiments of the present invention should not be treated as limiting the scope of the invention. It will be appreciated by those skilled in the art and informed by the teachings of the present invention that the concepts of the present invention can be advantageously applied in substantially any product advertising environment for the integration of the advertised products and supply means for the advertised products.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

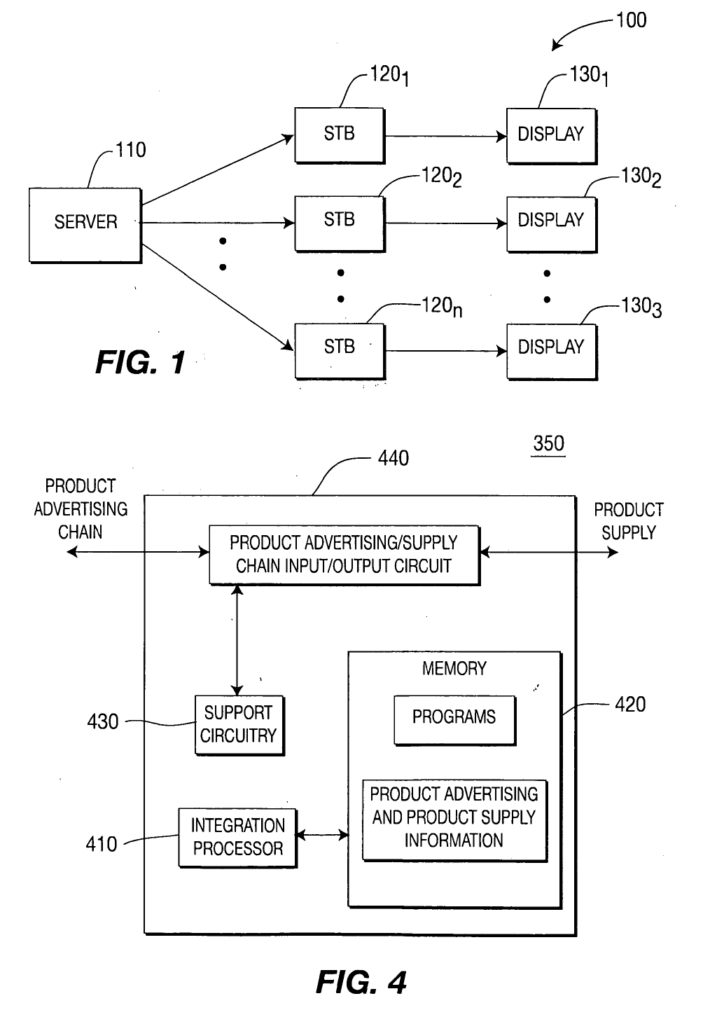

FIG. 1 depicts a high level block diagram of a content distribution system in which an embodiment of the present invention can be applied. The content distribution system 100 of FIG. 1 illustratively comprises at least one server 110, a plurality of tuning/decoding means (illustratively set-top boxes (STBs)) 120₁-120ₙ, and a respective display 130₁-130ₙ for each of the set-top boxes 120₁-120ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like.

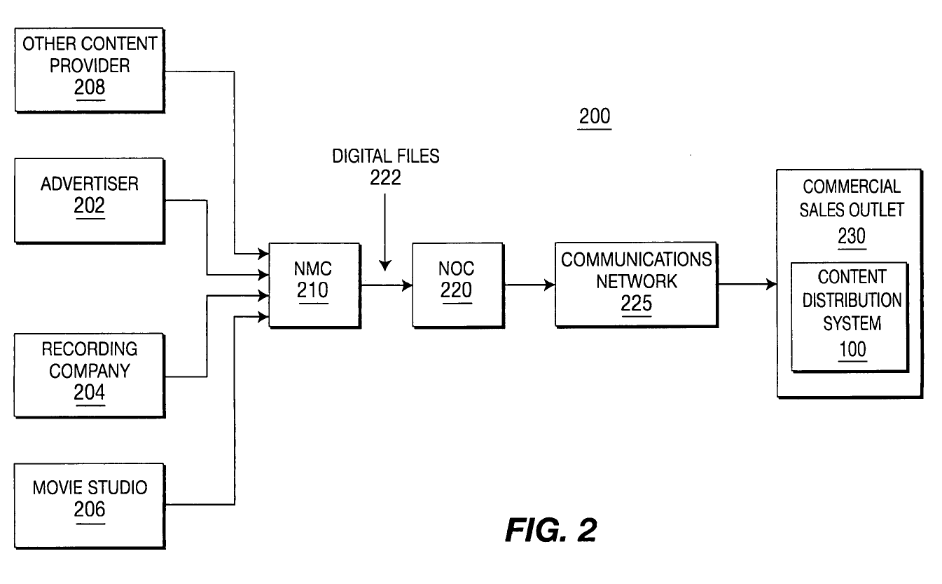

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various set-top boxes 120 and displays 130. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 can be located at specific locations throughout the sales outlet 230 and respectively configured to display content pertaining to products located within a predetermined distance from the location of each respective set-top box and display. The server 110 of the content distribution system 100 receives content and creates various different streams (e.g., content channels) to be communicated to the various set-top boxes 120 to be displayed by the displays 130. The streams can be individual channels of modulated audio/video onto a radio frequency distribution or transmitted as data flows within a unicast or multicast internet protocol (IP) network. These streams can originate from one or more servers under the same logical set of control software.

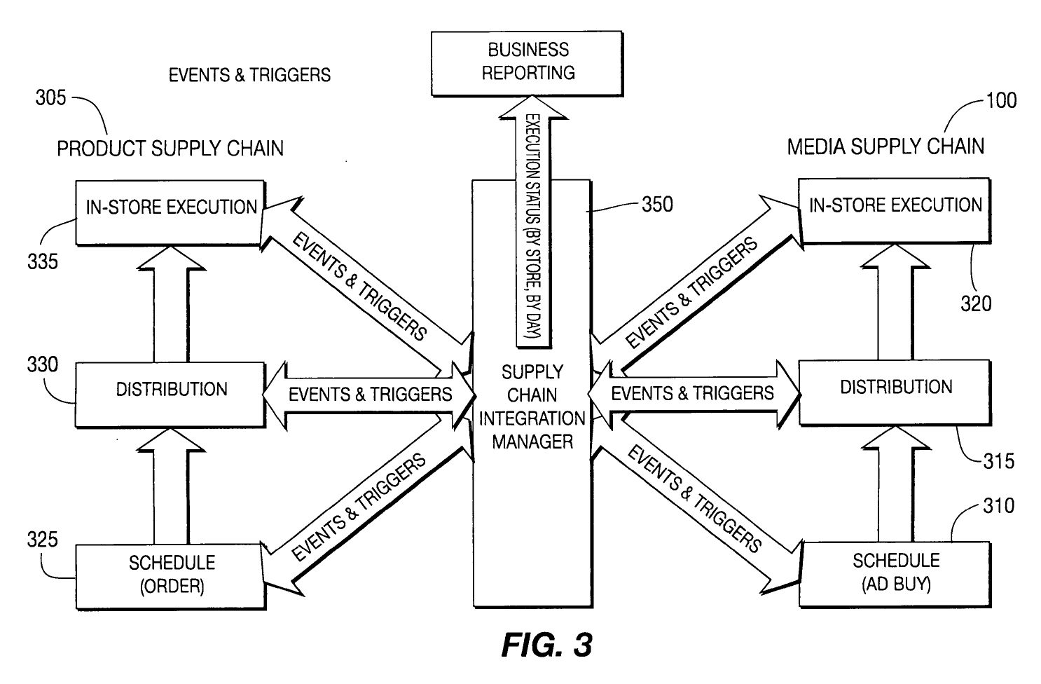

In accordance with the present invention, the content distribution system 100 of FIG. 1 can be integrated with a product supply chain to enable integration of the product advertising of the content distribution system 100 with a product supply means. FIG. 3 depicts a high level functional block diagram of the integration of the content distribution system 100 (illustratively labeled media supply chain) with a product supply chain 305 working in parallel with similar functions (“scheduling”, “distribution” and “in-store execution”) in accordance with an embodiment of the present invention. As depicted in FIG. 3, the media supply chain 100 includes a Schedule function 310, a Distribution function 315 and an Execution function 320. Similarly, the product supply chain 305 includes a Schedule function 325, a Distribution function 330 and an Execution function 335. The exemplary system of FIG. 3 further includes a Supply Chain Integration Manager 350. In one embodiment of the present invention, the Supply Chain Manager 350 can comprise a general purpose computer that is programmed to perform various control functions in accordance with the present invention. However, in alternate embodiments of the present invention, the Supply Chain Integration Manager 350 can also be implemented in hardware, for example, as an application specified integrated circuit (ASIC). As such, the process steps described herein are intended to be broadly interpreted as being equivalently performed by software, hardware, or a combination thereof.

For example, FIG. 4 depicts a high level block diagram of a Supply Chain Manager 350 suitable for use in the integrated system of FIG. 3 in accordance with one embodiment of the present invention. The Supply Chain Manager 350 of FIG. 3a illustratively comprises a product advertising/supply chain input-output circuit 440 that forms an interface between the product advertising chain, for example the content distribution system 100 of FIG. 1, the product supply chain, for example the product supply chain 305 of FIG. 3 and the Supply Chain Manager 350. For example, in one embodiment of the present invention, the Supply Chain Manager 350 can be in communication with the server 110 of the distribution system 100 of FIG. 1 for at least receiving information regarding product advertising content. However, in alternate embodiments of the present invention, the Supply Chain Manager 350 can be in communication with the NMC 210 and/or the NOC 220 of the in-store advertising network 200 of FIG. 2 for receiving at least information regarding product advertising content. The Supply Chain Manager 350 can also be in communication with the product supply chain 305 for receiving information regarding product availability.

The Supply Chain Manager further includes an integration processor 410 as well as a memory 420 for storing control programs, applications, product advertising information, supply information and the like. The integration processor 410 cooperates with conventional support circuitry 430 such as power supplies, clock circuits, cache memory and the like as well as circuits that assist in executing the software routines stored in the memory 420. As such, it is contemplated that some of the process steps discussed herein as software processes may be implemented within hardware, for example, as circuitry that cooperates with the integration processor 410 to perform various steps.

Although the Supply Chain Manager 350 of FIG. 4 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

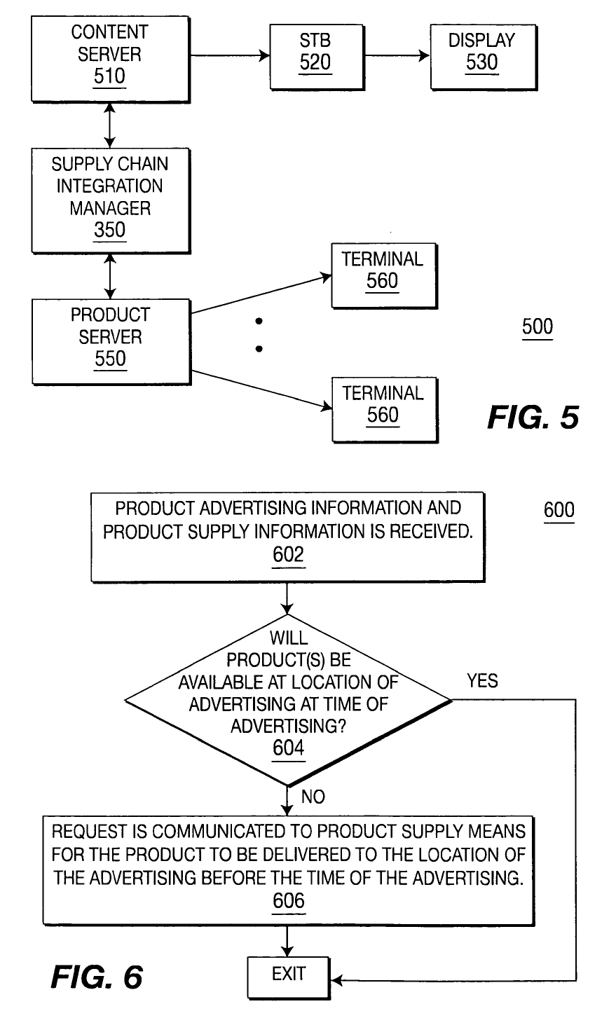

FIG. 5 depicts a more specific high level block diagram of a system for product advertising and supply chain integration in accordance with an embodiment of the present invention. The product advertising and supply chain integration system 500 of FIG. 5 illustratively comprises a content distribution system, such as the content distribution system 100 of FIG. 1, including a content server 510, at least one set-top box (STB) 520, and a respective display 530. The product advertising and supply chain integration system 500 of FIG. 5 further includes a product supply chain including a product server 550 and a plurality of local and remote terminals 560. The product advertising and supply chain integration system 500 of FIG. 5 further comprises a Supply Chain Manager 350 in communication with the content server 510 of the content distribution system and the product server 550 of the product supply chain.

In the embodiment of FIG. 5, the Supply Chain Manager 350 receives information regarding product advertising from the content server 510. That is, the Supply Chain Manager 350 receives information regarding a product to be advertised, where and when it will be advertised, how often it will be advertised and the like. In the embodiment of FIG. 5 the content server 510 can provide product advertising information to the Supply Chain Manager 350 for local product advertising and/or remote product advertising. That is, the content server 510 can receive information from, for example, the in-store advertising network 200 of FIG. 2 regarding advertising at the various locations of served by the network 200. As such, the Supply Chain Manager 350 can receive such information from the content server 510. Alternatively, and as described above, the Supply Chain Manager 350 can be in communication with a server of the in-store advertising network 200 for receiving such distributed product advertising information.

In the embodiment of FIG. 5, the Supply Chain Manager 350 receives information regarding product supply from the product server 550. That is, the product server 550 of FIG. 5 contains information regarding availability, delivery times, inventory and the like of the products to be advertised from a central location (e.g., a central warehouse) or various distributed locations (e.g., a plurality of dispersed warehouses). The product server 550 can obtain such product availability information from information input into the terminals 560 via a user interface (not shown) or from product sensors, such as handheld scanners, or shelf sensors which update the product server 550 when inventory status changes such as when product ships or product availability changes.

In an alternate embodiment of the present invention, the availability of product on a local shelf can be communicated to the Supply Chain Manager 350 for product advertising and supply chain integration in accordance with an embodiment of the present invention. More specifically, in accordance with various embodiments of the present invention, sensors can be located in the vicinity of products to be advertised for sensing the presence of product in a location near where the product is to be advertised. Such sensors can include cameras, pressure sensors and pads, RFID sensors and the like, and substantially any sensor that can indicate when a product has been removed or no longer exists in the vicinity of the intended advertising.

Information from such sensors regarding local product availability can be communicated to a server, such as the content server 510, for communication to the Supply Chain Manager 350 or to a remote network, such as the in-store advertising network 200 for communication to the Supply Chain Manager 350. Alternatively, the product availability information from the local sensors can be communicated directly to the Supply Chain Manager 350.

The Supply Chain Manger 350 then uses the product advertising information and product supply information to determining if a product to be advertised will be available at a location of the advertising during a time of the advertising of the product. In response to the determination that a product to be advertised will not be available at the location of advertising, the Supply Chain Manager performs various functions in accordance with the concepts of the present invention to attempt to ensure the availability of advertised products, including producing and communicating a request for the product to be delivered to the location of the advertising before the time of the advertising of the product. The request can be communicated to a local product inventory supply means (e.g., an in-store warehouse or stock room) or to a remote product inventory supply means (e.g., a central warehouse) for causing the delivery of the unavailable product to be advertised to the location of the advertising.

Although in the embodiment of FIG. 5, the Supply Chain Manager 350 is depicted as a separate, stand-alone component, in alternate embodiments of the present invention, the Supply Chain Manager 350 of the present invention can be integrated into an existing component or server, such as the content server 510 or the product server 550 of FIG. 5.

FIG. 6 depicts a high level flow diagram of a method for product advertising and supply chain integration in accordance with an embodiment of the present invention. The method 600 of FIG. 6 begins in step 602 at which product advertising information and product supply information is received by, for example, a Supply Chain Manager of the present invention. The method 600 then proceeds to step 604.

At step 604, the product advertising information and supply information is used to determine if a product to be advertised will be available at a location of the advertising during a time of the advertising of the product. If yes, the method 600 is exited. In alternate embodiments of the present invention instead of only determining if a product will be available, at step 604, it is determined if a threshold amount of product is available to support a projected amount of sales of the product in response to the advertising. If no, the method 600 proceeds to step 606.

At step 606, in response to the determination at step 604 that a product to be advertised (or a threshold amount of product) will not be available, a request for the product to be delivered to the location of the advertising before the time of the advertising of the product is communicated to, for example, a local or remote product supply means, such as a stockroom or warehouse. The method 600 is then exited.

The various functional aspects of a method, apparatus and system for product advertising and supply chain integration in accordance with various embodiments of the present invention can include the following:
Enabling “orders” that occur in the media-supply-chain to trigger complementary “orders”, “distribution” and “in-store execution” in the product-supply-chain. Configuring these triggers in a way that best enables the product-supply-chain to deliver the correct amount, of the correct products, to the correct stores, at the correct time.
Enabling information from the product-supply-chain (ex. product specific inventory status) to trigger changes in the “in-store execution” of the media-supply-chain. Configuring these triggers in a way that best enables the media-supply chain to display information for the correct products, in the correct stores, at the correct time.
Enabling information from the “in-store execution” function of the product-supply-chain to trigger corrective actions in the product-supply-chain when necessary (i.e., inventory in the product-supply-chain does not support the desired “in-store execution” in the media-supply-chain).

In one embodiment of the present invention and as depicted in FIG. 3, in the media-supply-chain specific advertising media content for a specific product is “scheduled” to play in certain stores for a certain period of time. Information about each media content schedule is communicated to the “distribution” process of the media-supply-chain 100 of FIG. 3. In addition and in accordance with various embodiments of the present invention, information about each product's media “schedule” is communicated to the product-supply-chain 305 to trigger the appropriate “ordering”, “distribution” and “in-store execution” of products being advertised. That is, based on information regarding the advertising schedule and from information inherently resident in the product-supply-chain 305, the product-supply-chain 305 is triggered to, in one embodiment, order the correct product, distribute the correct amount of product for each specific location at the correct time and execute in the correct stores, the correct merchandising, of the correct product, in the correct amount, for the correct period.

For example, in one embodiment of the present invention, to order the correct product, the media supply chain 100 and the product supply chain 305 working in parallel determine the type of product that is scheduled to be advertised, the type of advertisement and content (program type) that is scheduled to be displayed, the number of units/product/day/store required to support the program type, the number of days and number of stores scheduled for advertisement, the number of days (from order) that it takes for product to arrive at respective stores/locations and the scheduled start date of a program.

In one embodiment of the present invention, to distribute the correct amount of product, to the correct stores at the correct time, the media supply chain 100 and the product supply chain 305 working in parallel determine the amount of product ordered, the stores where the product/program is scheduled to be displayed, information about the projected demand by location (store), the number of days (from Distribution) that it takes for product to arrive in all stores and to be merchandised as desired and the scheduled start date of the program.

In one embodiment of the present invention, to execute in the correct stores, the correct merchandising, of the correct product, in the correct amount, for the correct period, the media supply chain 100 and the product supply chain 305 working in parallel to determine the product scheduled to be advertised in each store, the type(s) of media program scheduled for each product, the scheduled start and end date of each product's program, the projected demand for each product in each store during the program period, the amount of each product distributed to and currently on hand in each store and the desired merchandising location for each product in each store.

In one embodiment of the present invention, the media in-store execution is synchronized based on information from the “distribution” function of the media-supply-chain 100. That is, the correct stores are triggered to display advertising for the correct products, in the correct store locations, for the correct periods. Information in these triggers can include the media scheduled to air in each store, the location(s) at which individual media content is scheduled to play in each store, the frequency that each individual media content is scheduled to play and the scheduled start and end dates for each media program. In accordance with the present invention, media content will be displayed in the respective stores, at the respective locations, for the scheduled periods for the respective products, unless it has been determined that the product-supply-chain cannot meet the demand (i.e. sales) generated by the advertisement. That is, it is possible that scheduled media content may not air in some scheduled stores, at some scheduled locations, for some products, for some scheduled periods based on the status of the previously describe in-store execution status of the product-supply-chain, the distribution status of the product-supply-chain and the order status of the product-supply-chain.

Some of the product-supply-chain conditions that could result in scheduled media content not playing as scheduled can include, but are not limited to a threshold amount of scheduled product not being available in a scheduled store(s) during a scheduled period, a threshold amount of scheduled product not being available in a scheduled store(s) during a scheduled period and a threshold amount of the scheduled product not being available in the “distribution” function of the product-supply-chain during the same scheduled period, a threshold amount of scheduled product not being available in a scheduled store(s) during a scheduled period and a threshold amount of the scheduled product not being available in the “distribution” function of the product-supply-chain during the scheduled period and a threshold amount of the scheduled product not being available in the “order” function of the product-supply-chain during the scheduled period. In one embodiment of the present invention, the above described synchronization of the “in-store execution” process of media content and of the product-supply-chain occur continuously and on a real time basis. Optionally, the information regarding the status of the “in-store execution” process can also be communicated to a Business Reporting process which is described in greater detail below.

During the “in-store execution” function of the media-supply-chain, information can be shared with the product-supply-chain to trigger corrective actions related to product availability, inventory and the like. Such triggers will be communicated to the functions of the product-supply chain that are required to act in order to correct a product-supply-chain issue. For example, trigger information can be communicated to the “in-store execution” function of the product supply-chain, when a number of stores are not delivering the desired in-store execution, and when there is sufficient inventory in these stores to enable the desired execution. Such trigger information can further be communicated to the “distribution” function of the product-supply-chain, when a number of stores are not delivering the desired in-store execution and when there is not sufficient inventory in these stores to enable the desired execution. Even further, such triggers can also be communicated to the “order” function of the product-supply-chain, when a number of stores are not delivering the desired in-store execution and when there is not sufficient inventory in these stores to enable the desired execution and when there is not sufficient inventory in the “distribution” function to meet these stores' needs. The information in the triggers can include the number and identity of stores not executing as scheduled, the number and identity of stores not executing due to specific conditions, the scope of activity required by the supply chain to correct execution such as the amount of inventory required to be ordered to correct all store and location issues. Some specific conditions of non-execution can include information such as the required inventory is not in store(s) and is in “distribution” or that the required inventory is not in store(s) and is not in “distribution.

In accordance with various embodiments of the present invention, the integrated media and product supply-chains will operate in a coordinated and synchronized manner across all functions. For example, information and triggers from the product-supply-chain will be communicated to and optimize levels of the media-supply-chain. That is, changes can be made to the “distribution” and/or “scheduling” of a media content program if the product-supply-chain is unable to “order” and/or “distribute” a product associated with a scheduled or executing program as planned. Similarly, information and triggers from the media-supply-chain will be communicated to and optimize levels of the product-supply-chain. For example, changes can be made to the “distribution” and/or “scheduling” of product in the product-supply-chain if the media-supply-chain is unable to “distribute” a media program as planned. In various embodiments of the present invention, each supply-chain will have visibility into the active programs and functions of every other supply-chain. Individual programs will be tracked through each function, with, in one embodiment of the present invention, exception based reporting when execution of any program in any function is different that originally planned or expected.

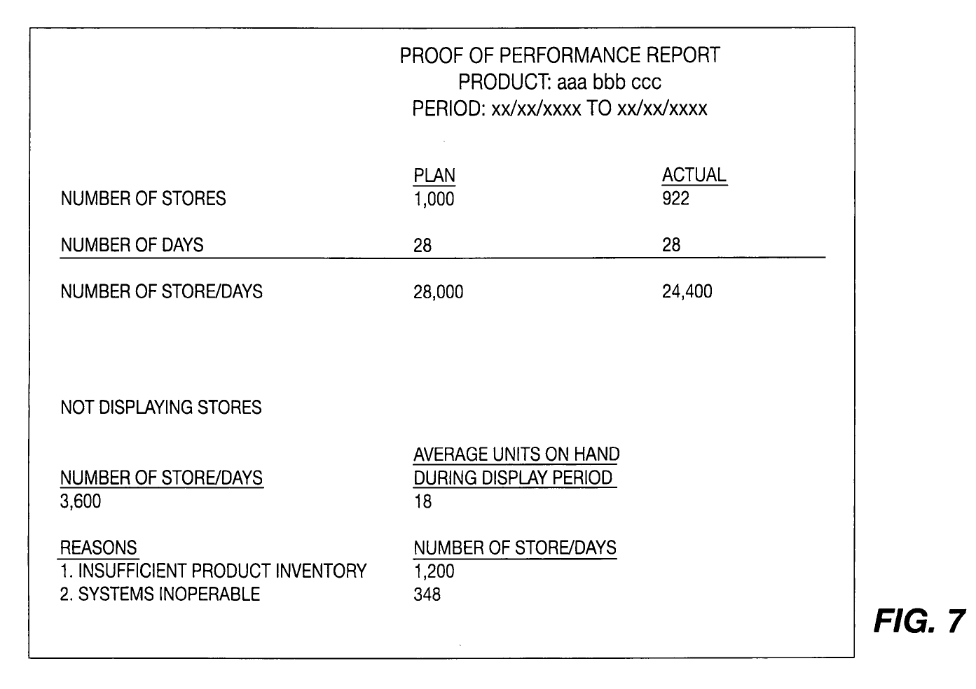

In one embodiment of the present invention, a Business Reporting function is incorporated into the functionality of the present invention. The Business Reporting function of the present invention provides reports and tools to various clients. For example, in one embodiment of the present invention, the Business Reporting function of the present invention provides Trigger reports which enable the product-supply-chain to address issues in ordering, distribution and/or in-store execution (see above for examples). The Business Reporting function of the present invention can further provide Dashboard reports which allow network providers and retailers to track in-store execution for both the media-supply-chain and the product-supply-chain. For example, in one embodiment of the present invention, Proof-of-Performance reports are provided which provide advertisers with an accounting of in-store execution vs. scheduling for each product/program. FIG. 7 depicts a table depicting and exemplary Proof-of-Performance report in accordance with an embodiment of the present invention. Reporting levels can be customized for each client. For example, individual distribution centers in the product-supply-chain can be limited to only receive exception based reporting for the specific stores which they service.

Having described various embodiments for a method, apparatus and system for providing integration of product advertising and product supply means (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for product advertising and supply chain integration, comprising:
using product advertising information and supply information, determining if a product to be advertised will be available at a location of the advertising during a time of the advertising of the product; and
in response to the determination that a product to be advertised will not be available, communicating a request for the product to be delivered to the location of the advertising before the time of the advertising of the product.

2. The method of claim 1, further comprising:
if a product to be advertised is not available for delivery, communicating information regarding the unavailability of the product to a source of the product advertising information.

3. The method of claim 2, wherein the unavailability of the product to be advertised causes said product not to be advertised.

4. The method of claim 1, wherein said product advertising information includes at least one of a type of product to be advertised, a time and frequency that a product is to be advertised, and a location at which a product will be advertised.

5. The method of claim 1, wherein delivery information is also used to determine if a product to be advertised will be available at a location of the advertising during a time of the advertising.

6. The method of claim 5, wherein said delivery information includes at least one of a location for delivering said product, an amount of time necessary for delivering a product, an amount of product to be delivered, and an amount of product available for delivery.

7. The method of claim 1, wherein said delivery request is communicated to a local product supply location.

8. The method of claim 1, wherein said delivery request is communicated to a remote product supply location.

9. The method of claim 1, wherein said product advertising information and delivery information are used to determine a projected demand for a product in response to advertising the product.

10. The method of claim 1, wherein a delivery failure of a product causes the product not to be advertised.

11. An apparatus for product advertising and supply chain integration, comprising:
a means for receiving product advertising information and product supply information; and
a means for using said received product advertising information and product supply information for determining if a product to be advertised will be available at a location of the advertising during a time of the advertising of the product, and in response to determining that the product to be advertised will not be available, communicating a request for the product to be delivered to a location at which the product is to be advertised before the time of the advertising of the product.

12. The apparatus of claim 11, wherein said means for receiving comprises a product advertising/supply chain input-output circuit.

13. The apparatus of claim 11, wherein said means for using comprises an integration processor.

14. A system for product advertising and supply chain integration, comprising:
a first means for providing product advertising information;
a second means for providing product supply information;
a third means for receiving said product advertising information and product supply information and using said received product advertising information and product supply information for determining if a product to be advertised will be available at a location of the advertising during a time of the advertising of the product, and in response to determining that the product to be advertised will not be available, communicating a request for the product to be delivered to a location at which the product is to be advertised before the time of the advertising of the product.

15. The system of claim 14, wherein said first means comprises a server of a content distribution system.

16. The system of claim 14, wherein said first means comprises a server of an in-store advertising network.

17. The system of claim 14, wherein said second means comprises a computer of a supply system.

18. The system of claim 14, wherein said third means comprises a supply chain integration manager.

19. The system of claim 14, wherein said second means comprises a sensor for detecting products.

20. The system of claim 14, wherein if a product to be advertised is not available for delivery, said third means communicates information regarding the unavailability of the product to said first means.

21. The system of claim 20, wherein said first means causes the unavailable product not to be advertised.

22. The system of claim 14, wherein said third means determines a projected demand for a product in response to the product advertising information.

23. The system of claim 22, wherein said product advertising information further includes historical sales data.

24. A method for product advertising and supply integration, comprising:
providing intercommunication between an advertising means and a product supply means such that when a product is to be advertised by said advertising means, said advertising means is able to determine if said product is in supply.

25. The method of claim 24, wherein if said product is not in supply in proximity of a playout device intended to advertise said product, said advertising means performs at least one of requesting said product supply means to provide said product in proximity to said playout device and using said playout device to advertise an alternate product that is in proximity to said playout device.
